(19) United States
(12) Patent Application Publication
(10) Pub. No.: US 2023/0161879 A1
(43) Pub. Date: May 25, 2023

(54) MALICIOUS CODE DETECTION METHOD AND APPARATUS BASED ON ASSEMBLY LANGUAGE MODEL

(71) Applicant: ELECTRONICS AND TELECOMMUNICATIONS RESEARCH INSTITUTE, Daejeon (KR)

(72) Inventors: Ki Jong KOO, Daejeon (KR); Jung Tae KIM, Daejeon (KR); Jong Hyun KIM, Daejeon (KR); Dae Sung MOON, Daejeon (KR); Sang Min LEE, Daejeon (KR); Ik Kyun KIM, Daejeon (KR); Ji Hyeon SONG, Daejeon (KR)

(21) Appl. No.: 18/056,141

(22) Filed: Nov. 16, 2022

(30) Foreign Application Priority Data
Nov. 23, 2021 (KR) 10-2021-0162783
May 17, 2022 (KR) 10-2022-0059945

(51) Int. Cl. G06F 21/55

(52) U.S. Cl. CPC G06F 21/554; G06F 2221/034

(57) ABSTRACT

Disclosed herein a method and apparatus for detecting a malicious code based on an assembly language model. According to an embodiment of the present disclosure, there is provided a method for detecting a malicious code. The method comprising: generating an instruction code sequence by converting an input file, for which a malicious code is to be detected, into an assembly code; embedding the instruction code sequence by using a prelearned assembly language model for instruction code embedding and outputting an embedding result of the instruction code sequence; and detecting whether or not the input file is a malicious code, by using a prelearned malicious code classification model with the embedding result as an input.

### CROSS REFERENCE TO RELATED APPLICATION

The present application claims priority to Korean patent applications 10-2021-0162783, filed Nov. 23, 2021, and 10-2022-0059945, filed May 17, 2022, the entire contents of which are incorporated herein for all purposes by this reference.

### BACKGROUND OF THE INVENTION

### Field of the Invention

The present disclosure relates to a technology of detecting a malicious code, and more particularly, to a method and apparatus for detecting a malicious code based on an assembly language model.

### Description of the Related Art

A conventional malicious code detection method is a signature-based detection method that detects a malicious code by matching pattern information of a specific code section of the malicious code to a file that is suspected to be a malicious code. Especially, since the existing antivirus detection method is based on byte information of a specific code section used by a malicious code or determines a malicious code based on various log information (e.g., DLL, API function call information, etc.), which the malicious code generates in its dynamic operation, and file structure information, there is a limitation in detecting new and variant malicious codes.

A variety of static technologies and dynamic technologies for malicious code analysis are being proposed, and in particular, the malicious code analysis and detection in recent years attempts to apply AI technology for detecting unknown files. Although an attempt is being made to effectively analyze and detect various types of malicious codes based on instruction information that occurs during a static/dynamic analysis of malicious code, this technology is still difficult to commercialize due to its limitations of accuracy and performance.

### SUMMARY

A technical object of the present disclosure is to provide a method and apparatus for detecting a malicious code based on an assembly language model.

Other objects and advantages of the present invention will become apparent from the description below and will be clearly understood through embodiments. In addition, it will be easily understood that the objects and advantages of the present disclosure may be realized by means of the appended claims and a combination thereof.

Disclosed herein a method and apparatus for detecting a malicious code based on an assembly language model. According to an embodiment of the present disclosure, there is provided a method for detecting a malicious code. The method comprising: generating an instruction code sequence by converting an input file, for which a malicious code is to be detected, into an assembly code; embedding the instruction code sequence by using a prelearned assembly language model for instruction code embedding and outputting an embedding result of the instruction code sequence; and detecting whether or not the input file is a malicious code, by using a prelearned malicious code classification model with the embedding result as an input.

According to the embodiment of the present disclosure, the method further comprising generating an indexed instruction code sequence corresponding to the instruction code sequence by using an instruction code dictionary for indexing an instruction code by an integer and by indexing an instruction code in the instruction code sequence by an integer, wherein the outputting of the embedding result outputs an embedding result of the indexed instruction code sequence by embedding the indexed instruction code sequence.

According to the embodiment of the present disclosure, wherein the generating of the instruction code sequence generates a plurality of segment instruction code sequences by segmenting the instruction code sequence by a randomly selected length.

According to the embodiment of the present disclosure, wherein the generating of the instruction code sequence generates each of the plurality of segment instruction code sequences as an individual file.

According to the embodiment of the present disclosure, wherein the generating of the instruction code sequence extracts an instruction from the assembly code, generates an instruction code by combining an opcode and an operand of the extracted instruction, and generates the instruction code sequence by using the instruction code.

According to another embodiment of the present disclosure, there is provided a method for detecting a malicious code. The method comprising: generating an instruction code sequence by converting each of a plurality of execution files into an assembly code; learning an assembly language model for instruction code embedding by using the instruction code sequence; and learning a malicious code classification model for detecting a malicious code based on the learned assembly language model.

According to another embodiment of the present disclosure, the method further comprising generating an indexed instruction code sequence corresponding to the instruction code sequence by using an instruction code dictionary for indexing an instruction code by an integer and by indexing an instruction code in the instruction code sequence by an integer, wherein the learning of the assembly language model learns the assembly language model by using the indexed instruction code sequence.

According to another embodiment of the present disclosure, wherein the learning of the assembly language model learns the assembly language model by performing a masked language model (MLM) task and a next sentence prediction (NSP) task of the assembly language model by using the indexed instruction code sequence.

According to another embodiment of the present disclosure, wherein the learning of the assembly language model learns the assembly language model by treating the indexed instruction code sequence as a sentence and by treating each instruction code as a token.

According to another embodiment of the present disclosure, wherein the learning of the assembly language model learns the assembly language model by using a vector that adds token embedding for the indexed instruction code sequence, position embedding for a position of an instruction code, and segment embedding for distinguishing two indexed instruction code sequences.

According to another embodiment of the present disclosure, wherein the generating of the instruction code sequence generates a plurality of segment instruction code sequences by segmenting the instruction code sequence by a randomly selected length.

According to another embodiment of the present disclosure, wherein the generating of the instruction code sequence generates each of the plurality of segment instruction code sequences as an individual file.

According to another embodiment of the present disclosure, wherein the generating of the instruction code sequence extracts an instruction from the assembly code, generates an instruction code by combining an opcode and an operand of the extracted instruction, and generates the instruction code sequence by using the instruction code.

According to another embodiment of the present disclosure, there is provided an apparatus for detecting a malicious code. The apparatus comprising: a collector configured to generate an instruction code sequence by converting an input file, for which a malicious code is to be detected, into an assembly code; an output unit configured to embed the instruction code sequence by using a prelearned assembly language model for instruction code embedding and to output an embedding result of the instruction code sequence; and a detector configured to detect whether or not the input file is a malicious code, by using a prelearned malicious code classification model with the embedding result as an input.

The features briefly summarized above with respect to the present disclosure are merely exemplary aspects of the detailed description below of the present disclosure, and do not limit the scope of the present disclosure.

According to the present disclosure, it is possible to provide a method and apparatus for detecting a malicious code based on an assembly language model.

Effects obtained in the present disclosure are not limited to the above-mentioned effects, and other effects not mentioned above may be clearly understood by those skilled in the art from the following description.

### BRIEF DESCRIPTION OF THE DRAWINGS

FIG. 1 is a flowchart for a process of learning a malicious code detection model according to an embodiment of the present disclosure.

FIG. 2 is a view for describing an example process of learning a malicious code detection model.

FIG. 3 is a flowchart for a method of detecting a malicious code according to another embodiment of the present disclosure.

FIG. 4 is a view for describing an example process of detecting a malicious code.

FIG. 5 is a view exemplifying an instruction code structure.

FIG. 6 is a view exemplifying results converted into instructions with an assembly language format.

FIG. 7 is a view exemplifying an encoding result of an instruction code.

FIG. 8 is a view exemplifying a coding table of instruction codes.

FIG. 9 is a view exemplifying an instruction code sequence.

FIG. 10 is a view exemplifying a divided instruction code sequence.

FIG. 11 is a view exemplifying an instruction code dictionary.

FIG. 12 is a view exemplifying an instruction code input sequence.

FIG. 13 is a view exemplifying an MLM technique using an instruction code sequence.

FIG. 14 is a view exemplifying an NSP technique using an instruction code sequence.

FIG. 15 is a view showing a configuration of a malicious code detection apparatus according to yet another embodiment of the present disclosure.

FIG. 16 is a view showing a configuration of a device to which a malicious code detection apparatus according to yet another embodiment of the present disclosure is applicable.

### DETAILED DESCRIPTION OF THE INVENTION

Hereinafter, exemplary embodiments of the present disclosure will be described in detail with reference to the accompanying drawings so that those skilled in the art may easily implement the present disclosure. However, the present disclosure may be implemented in various different ways, and is not limited to the embodiments described therein.

In describing exemplary embodiments of the present disclosure, well-known functions or constructions will not be described in detail since they may unnecessarily obscure the understanding of the present disclosure. The same constituent elements in the drawings are denoted by the same reference numerals, and a repeated description of the same elements will be omitted.

In the present disclosure, when an element is simply referred to as being “connected to”, “coupled to” or “linked to” another element, this may mean that an element is “directly connected to”, “directly coupled to” or “directly linked to” another element or is connected to, coupled to or linked to another element with the other element intervening therebetween. In addition, when an element “includes” or “has” another element, this means that one element may further include another element without excluding another component unless specifically stated otherwise.

In the present disclosure, elements that are distinguished from each other are for clearly describing each feature, and do not necessarily mean that the elements are separated. That is, a plurality of elements may be integrated in one hardware or software unit, or one element may be distributed and formed in a plurality of hardware or software units. Therefore, even if not mentioned otherwise, such integrated or distributed embodiments are included in the scope of the present disclosure.

In the present disclosure, elements described in various embodiments do not necessarily mean essential elements, and some of them may be optional elements. Therefore, an embodiment composed of a subset of elements described in an embodiment is also included in the scope of the present disclosure. In addition, embodiments including other elements in addition to the elements described in the various embodiments are also included in the scope of the present disclosure.

In the present document, such phrases as ‘A or B’, ‘at least one of A and B’, ‘at least one of A or B’, ‘A, B or C’, ‘at least one of A, B and C’ and ‘at least one of A, B or C’ may respectively include any one of items listed together in a corresponding phrase among those phrases or any possible combination thereof.

When analyzing a malicious code by using an artificial intelligence technology, it is first necessary to determine data to be input into a neural network model. Generally, there are three options: raw bytes, manually-designed features, and an instruction representation vector. A deep neural network (DNN) and a convolution neural network (CNN) are usually used to process raw bytes and feature data, and a representation learning model and a DNN model for a downstream task are used to process an instruction representation vector.

A representation learning model automatically learns a vector representation for each instruction and then generates an instruction representation vector for an input instruction. Typical representation learning models are word2vec, PV-DM (Distributed Memory version of Paragraph Vector), BERT (Bidirectional Encoder Representation Transformer), which are devised in the field of natural language processing (NLP).

Recently, instruction level representation learning is highlighted in virtue of the allegedly advantages that the troublesome manual design of features can be avoided and a high-level feature can be learned. Most of all, BERT with excellent embedding (or representation) performance is actively utilized as a representation learning model. BERT is an NLP prelearning model developed by Google, and it is a general-purpose language model showing good performance in most NLP areas.

In embodiments of the present disclosure, a technology of detecting an unknown malicious code based on an artificial intelligence is used to generate an assembly language model through instruction information utilized for a static/dynamic malicious code analysis and to detect an unknown malicious code based on the model.

Herein, in the embodiments of the present disclosure, a representation learning model (that is, an assembly language model) capable of embedding an instruction code may be learned by using the BERT model, and a malicious code classification model (or malicious code detection model) for determining whether or not an unknown code is malicious may be learned by using an instruction code embedding vector generated from a prelearned assembly language model, and thus it may be detected whether or not an unknown code is a malicious code.

For this, in the embodiments of the present disclosure, detection of an unknown malicious code may be performed through collection of instructions for assembly language model learning data, preprocessing of the collected learning data, prelearning of the assembly language model, and malicious code classifier learning based on the assembly language model.

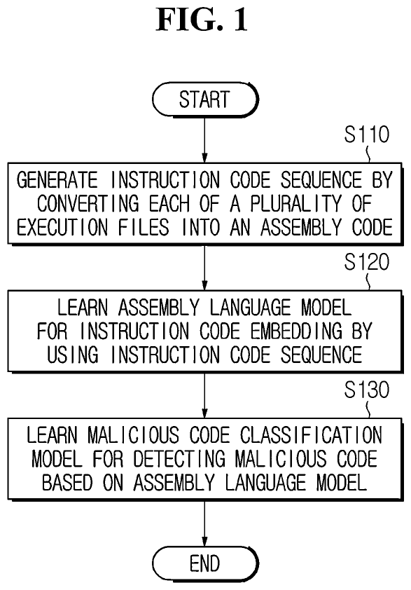

FIG. 1 is a flowchart for a process of learning a malicious code detection model according to an embodiment of the present disclosure, that is, a flowchart for a process of learning a malicious code detection model based on an assembly language model.

Referring to FIG. 1, a process of learning a malicious code detection model includes generating an instruction code sequence by converting each of a plurality of execution files into assembly codes (S110), learning an assembly language model for instruction code embedding by using the instruction code sequence (S120), and learning a malicious code classification model for detecting a malicious code based on the learned assembly language model (S130).

Step S110 may include a process of generating learning data for learning an assembly language model, that is, a process of generating an indexed instruction code sequence corresponding to an instruction code sequence by indexing an instruction code in the instruction code sequence by an integer using an instruction code dictionary for indexing an instruction code by an integer, and at step S120, the assembly language model may be learned using the indexed instruction code sequence thus generated.

Herein, at step S110, a plurality of segment instruction code sequences is generated by segmenting an instruction code sequence by a randomly selected length, and each of the plurality of segment instruction code sequences may be generated as an individual file.

Furthermore, at step S110, an instruction may be extracted from an assembly code, an instruction code may be generated by combining an opcode of the extracted instruction and an operand, and an instruction code sequence may be generated using the instruction code.

At step S120, the assembly language model is learned by performing a masked language model (MLM) task and a next sentence prediction (NSP) task of the assembly language model by using the indexed instruction code sequence.

Herein, at step S120, the assembly language model may be learned by treating the indexed instruction code sequence as a sentence and each instruction code as a token.

Furthermore, at step S120, the assembly language model may be learned using a vector that adds token embedding for an indexed instruction code sequence, position embedding for a position of an instruction code, and segment embedding for distinguishing two indexed instruction code sequences.

At step S130, a malicious code detection model (or malicious code classification model) is learned which is generated by adding a neural network layer for malicious code classification based on the assembly language model that is learned through step S120.

Herein, at step S130, the malicious code detection model may be learned by using indexed instruction code sequence data labeled with malware and benign.

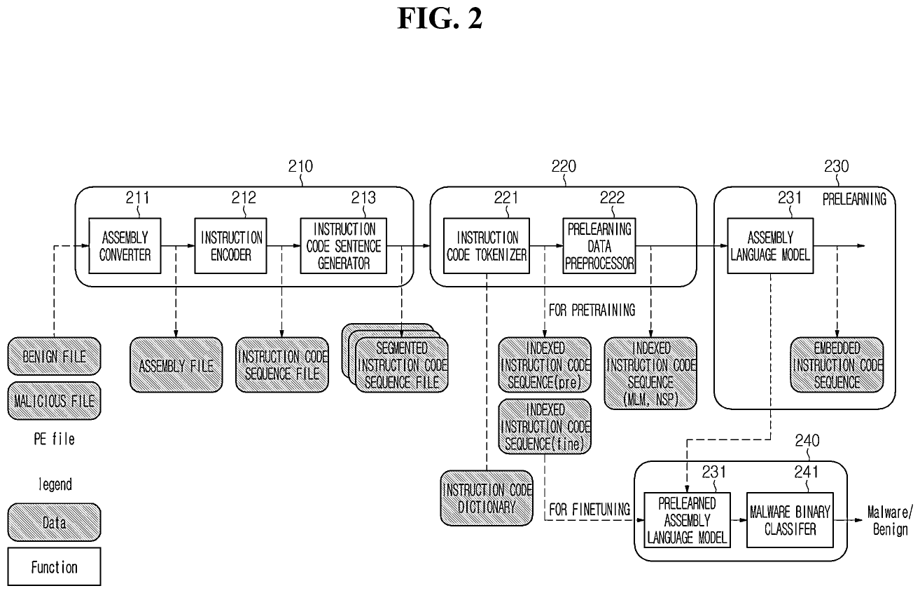

Such a learning process will be described in detail with reference to FIG. 2.

FIG. 2 is a view for describing an example process of learning a malicious code detection model, including collecting an instruction for learning data of an assembly language model (210), preprocessing collected learning data (220), prelearning the assembly language model (230), and learning a malicious code classifier based on the assembly language model (240).

Various binary analysis tools (Disassembler) may be used to extract an instruction code during a static/dynamic analysis of malicious code. In particular, depending on features like the OS of an analysis system, IDA, Objdump, OllyDBG, VisualStudio, and PE Explorer statically support extraction of an instruction. In addition, in case of a dynamic analysis, instruction extraction/conversion is also possible in a CPU like a processor tracer or a virtual environment. Reverse engineering based on a general binary analysis is a passive method referring to all the various static/dynamic information (e.g., file type, size, header information, certificate, internal structure, registry, network operation, relevant API function information), but the embodiments of the present disclosure basically use only an instruction that occurs from a static/dynamic analysis. In addition, a packed and obfuscated malicious code should be processed by deobfuscation in order to collect opcodes, but no detailed description about the process is provided herein because it does not belong to the key technology of the present disclosure.

As for the step (210) of collecting an instruction for learning data of an assembly language model, the step (210) of collecting an instruction for AI-based learning data is implemented by using an assembly converter 211 that converts a portable executable (PE) file into an assembly code, an instruction encoder 212 that extracts an instruction from an assembly file and generates an instruction code by combining an opcode and an operand, and an opcode sentence generator 213 that generates a sentence in an opcode according to a learning data input format of an assembly language model.

The assembly converter 211 converts an executable file (PE, DLL, etc.) into an Intel X86 assembly format file by using various binary analysis tools and extracts an instruction sequence from the assembly format file thus converted. A conventional assembly format file is composed of 4 basic segments, for example, .text segment, idata segment, irdata segment, and .data segment. In an embodiment of the present disclosure, since only .text segment stores program instructions, only .text segment is considered to extract an instruction sequence. Actually, an instruction sequence may reflect a program execution logic corresponding to an execution file.

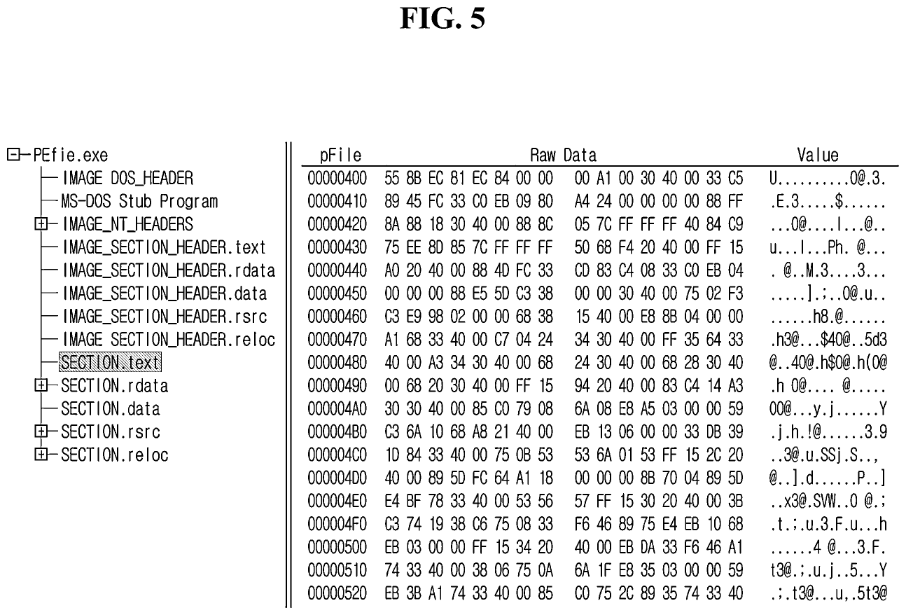

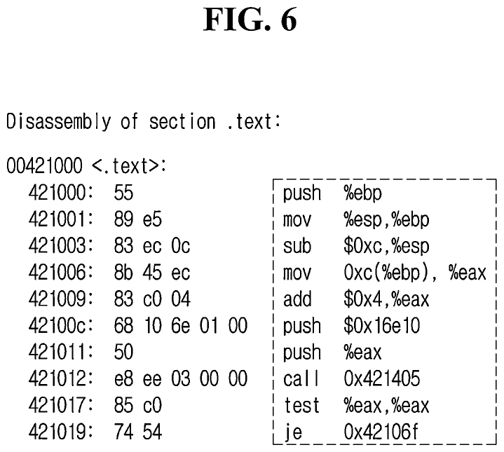

FIG. 5 is a view exemplifying an instruction code structure, FIG. 6 is a view exemplifying results converted into instructions with an assembly language format. and an assembly converter may convert raw data present in SECTION_text of FIG. 5 into an instruction with an assembly language format, as illustrated in FIG. 6, by using various binary analysis tools.

The instruction encoder 212 extracts an instruction from an assembly file converted by the assembly converter 211 and generates an instruction code by combining an opcode and an operand. As an instruction is basically a machine language instruction processed by a CPU, it provides functions of logical operation, program flow control, memory processing and arithmetic operation. The structure of an instruction may consist of 1 or 2-byte opcode and several operand values. Table 1 below shows example opcodes characteristic of each group.

TABLE 1

| Group | Opcode |
|---|---|
| Arithmetic operations | add, sub, mul, div |
| Memory manipulation | lea, pop, push, mov, store, load |
| Logical operations | xor, not, and, or |
| Program flow control | call, cmp, rep |
| Condition operation | Goto, jmp, if, spa, sna, sza |

Each row in FIG. 6 corresponds to a single instruction such as ‘push ebp’, ‘mov esp, ebp’ and the like. In an embodiment of the present disclosure, an instruction code composed of an opcode and an operand is generated to make each instruction a single word or token that is used in an assembly language model.

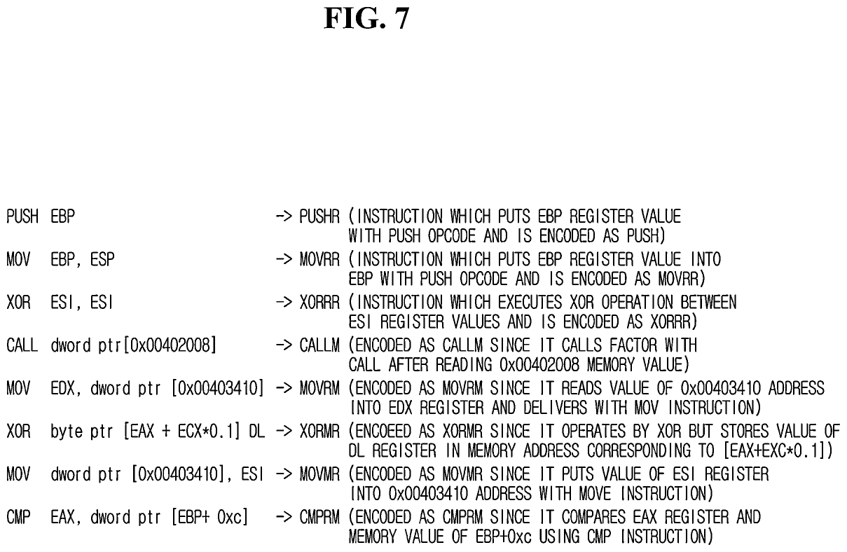

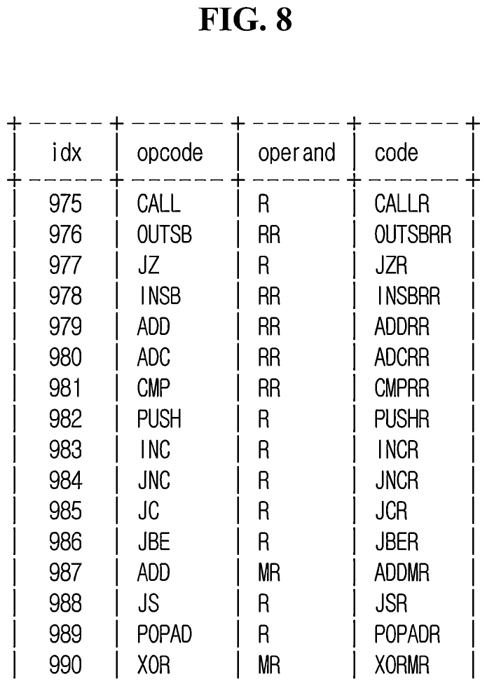

Operands may refer to either arithmetic registers like EAX and stack frame registers like EBP, which are referred to collectively as “registers,” or “memory,” which includes code or data areas. Accordingly, in an embodiment of the present disclosure, the extracted instructions may be classified by combining the following three: an opcode, the number of operands, and an access type of an operand. For example, as illustrated in FIG. 7, by encoding an instruction code using “M” for memory reference and “R” for register reference, a unique code may be generated including as many reference marks as the number of operands in each opcode. Herein, as shown in FIG. 7, the instruction encoder 212 may encode an instruction code by using the instruction code coding table illustrated in FIG. 8.

In addition, encoding may be performed by dividing register types. That is, registers are classified into general ones (EAX, EBX, ECX, EDX), segment ones (CS, DS, ES, FS, GS, SS), index and pointers (ESI, EDI, EBP, EIP, ESP) and an indicator (EFLAGS), and each specific register may be marked by assigning an index number. For example, EAX, EBX, ESI and ESP may be expressed by R0, R1, R11 and R15 respectively. When this process is implemented, an instruction code may further be divided so that it can be encoded in such a form as MOV_R0_R13.

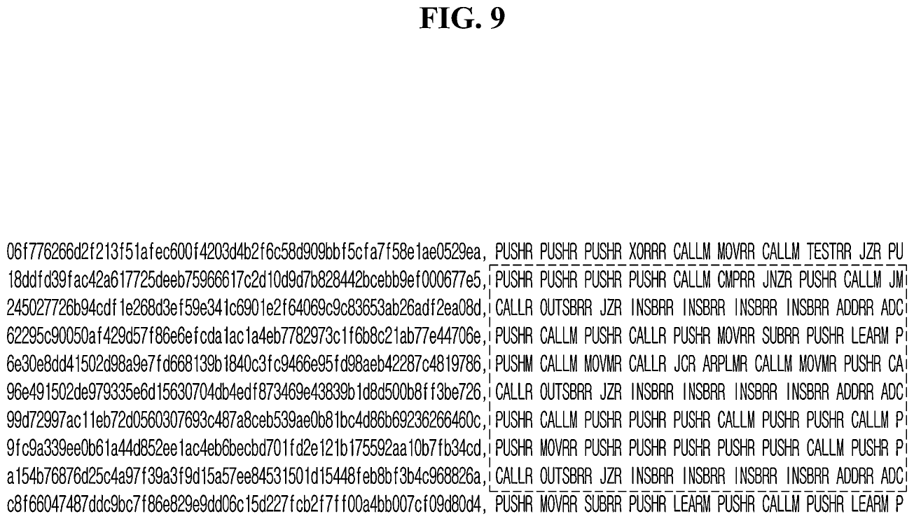

The opcode sentence generator 213 generates a sentence in an opcode suitable for a learning data input format of an assembly language model from an instruction code sequence file output from the instruction encoder 212. That is, the opcode sentence generator 213 extracts instructions of a malicious file and a benign file for learning/testing at the instruction collection step, and when an instruction code is generated, generates instruction code sequences with various lengths consisting of instruction codes in each execution file, as illustrated in FIG. 9.

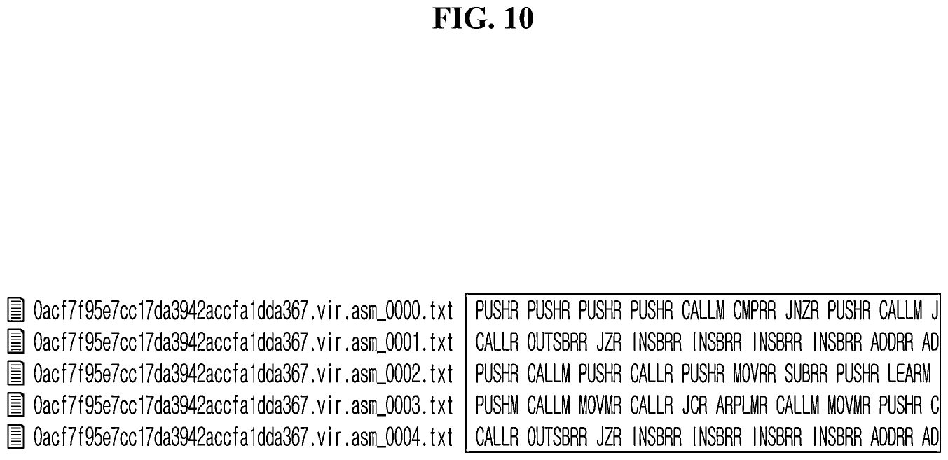

In addition, the opcode sentence generator 213 converts an instruction code sequence into an input sentence form of an assembly language model. Herein, a sentence length may be variably generated, and after the length is randomly selected within a predetermined range (e.g., at least 64 and not exceeding 512), an instruction code may be extracted as long as a value thus selected and be stored in a separate file, for example, in a text file. For each execution file, a whole instruction code sequence may be segmented and extracted in the above-described method and thus individual files may be generated, and as an example, as illustrated in FIG. 10, a serial number may be consecutively generated for each segment file so that the context of instruction code sequences thus segmented can be identified.

In this process, at the step of collecting instructions for learning data of an assembly language model, each of a plurality of execution files including benign and malicious files may be generated as a segment instruction code sequence file. As for the step (220) of preprocessing collected learning data, an instruction code tokenizer 221 generates an indexed instruction code sequence by using an instruction code dictionary that is built up beforehand.

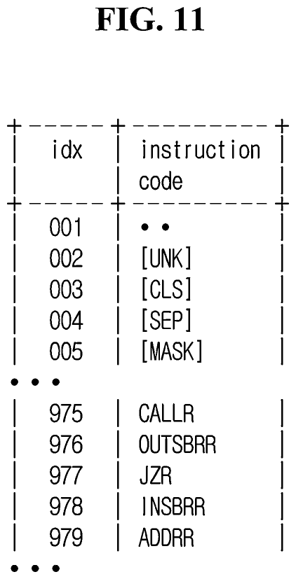

Herein, as illustrated in FIG. 11, the instruction code dictionary is for indexing an instruction code by an integer for a learning dataset consisting of a segmented instruction code sequence file. That is, in an embodiment of the present disclosure, an instruction code dictionary is built up which is capable of considering each instruction code as an individual token and indexing every instruction code that appears in whole learning data.

The instruction code tokenizer 221 may utilize a special token for model learning and token indexing exception processing. Examples of special tokens may include ‘ ’ for marking a blank, ‘[UNK]’ for indexing a token not in the dictionary, ‘[MASK]’ for masking an individual token, ‘[CLS]’ for indicating a start of a sequence, and ‘[SEP]’ for distinguishing two sequences (sentences). In addition, with reference to the instruction code dictionary, an instruction code sequence used as learning data is indexed, and an instruction code sequence indexed by an integer is generated.

Embodiments of the present disclosure provide an assembly language model for embedding an instruction code and a malware binary classification model using the assembly language mode, for example, a malicious code detection model. Herein, the assembly language model may be based on the BERT (Bidirectional Encoder Representation from Transformer) model proposed by Google, but the assembly language model is not necessarily restricted or limited to the BERT model and may be generated by using every scheme and artificial intelligence capable of generating an assembly language model.

Herein, in embodiments of the present disclosure, an assembly language model for embedding an instruction code is prelearned, and a masked language model (MLM) task using an instruction code sequence and a next sentence prediction (NSP) task are performed for the prelearning of the assembly language model.

In order to perform an MLM task, for a given input instruction code sequence, 15% of tokens are randomly selected and changed first. 80% of the selected tokens are changed to [MASK] tokens so that the original tokens/words (instruction codes) are masked. 10% of the selected tokens are changed to an already existing token, for example, a word, a corrupted token and the like. The remaining 10% are not changed.

In order to understand a contextual relation of an instruction sequence, a binarized NSP task is performed. An NSP task may be simply generated in an instruction sequence dataset. As an example of prelearning, when two instruction sequences A and B are selected, an actual instruction sequence following A is selected 50% of the times of selecting B, and an instruction sequence randomly selected in a dataset is used the remaining 50% of those of selecting B. Herein, in case an actual instruction sequence following A is selected, it may be labeled IsNext.

A prelearning data preprocessor 222 generates an indexed instruction code sequence for prelearning of an assembly language model through an MLM task and an NSP task. That is, the prelearning data preprocessor 222 preprocesses an indexed instruction code sequence of an instruction code tokenizer 221 as an indexed instruction code sequence (MLM, NSP) for an MLM task and an NSP task.

As for the step (230) of prelearning an assembly language model, in an embodiment of the present disclosure, an assembly language model 231 for instruction code embedding is based on the BERT model, which is a latest prelearned model useful for natural language processing (NLP) tasks. BERT is an encoder representation learning model with a multi-layer bidirectional transformer, and the transformer has a sequence modeling structure using an attention technique alone, which is a technology first introduced in 2017.

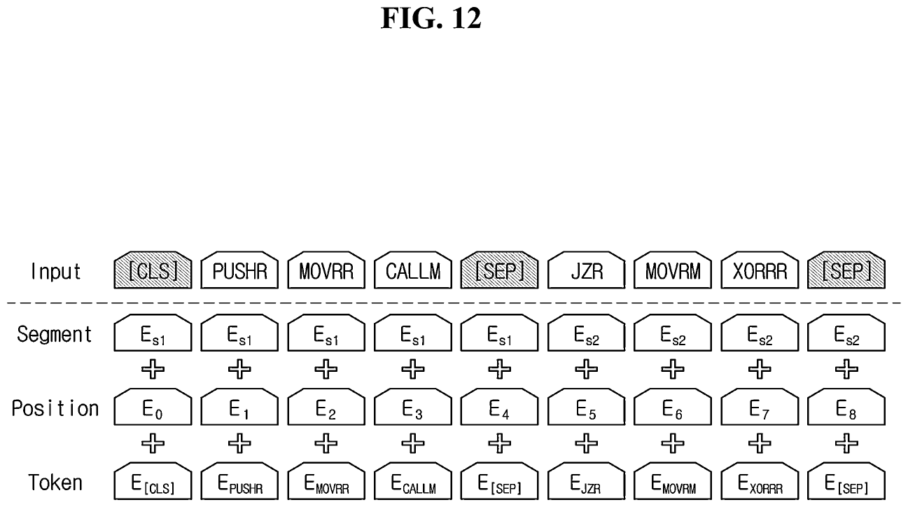

In embodiments of the present disclosure, an instruction code sequence is treated as a sentence, and each instruction code is treated as a token. As illustrated in FIG. 12, a special token [CLS] indicating a start of a sequence is used as a first token of an instruction code sequence, and a [SEP] token is used to distinguish two connected sentences (instruction code sequences). Herein, by adding position embedding and segment embedding to a token embedding result, a mixed vector may be used as an input into a bidirectional transformer network.

Position embedding is for expressing different positions of each instruction code in an input instruction code sequence, and segment embedding is for distinguishing a first one and a second one of two instruction code sequences. Herein, position embedding and segment embedding may be learned together with token embedding. These two types of embedding, that is, position embedding and segment embedding may help to dynamically adjust token embedding according to positions.

The assembly language model 231 may be learned by performing two types of prelearning tasks (MLM, NSP) using an instruction code sequence. A first task for prelearning the assembly language model 231 is a masked language model (MLM) task using an instruction code sequence. An instruction code sequence (I) may consist of an instruction code token t, and be represented as in Equation 1 below.

I=t₁, t₂, t₃, . . . , tₙ [Equation 1]

In order to perform an MLM task, for a given input instruction code sequence, 15% of tokens are randomly selected and changed first. 80% of the selected tokens are changed to [MASK] tokens so that the original tokens/words (instruction codes) are masked. 10% of the selected tokens are changed to an already existing token, for example, a word, a corrupted token and the like. The remaining 10% are not changed.

Next, a transformer encoder is learned to predict a masked token and a corrupted token. Then, a prediction probability of a specific token tᵢ=[MASK] is output to a softmax layer located on the top of a transformer network. Herein, the assembly language model 231 may be trained with a cross entropy loss function.

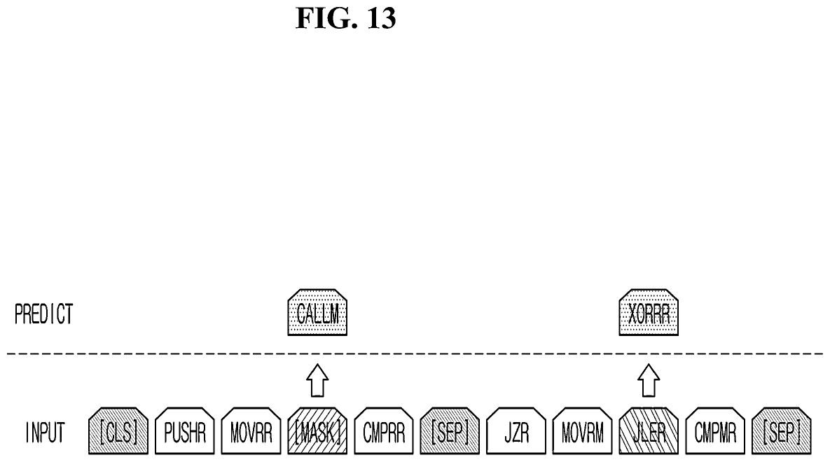

FIG. 13 is a view exemplifying an MLM technique using an instruction code sequence, and as illustrated in FIG. 13, for a given pair of instruction code sequences, first, special tokens [CLS] and [SEP] are added, and then several tokens are randomly selected for change. For example, in FIG. 13, CALLM and XORRR are selected as tokens to be changed, the token CALLM is changed to [MASK] token, and the token XORRR may be changed to another token JLER in an instruction code dictionary. Next, a modified instruction code sequence is input into the assembly language model, and the assembly language model performs prediction for each token. It is considered only whether or not the assembly language model predicts well a [MASK] token and a XORRR token, which is a corrupted token. Prediction for the two special tokens alone is considered to calculate a loss function.

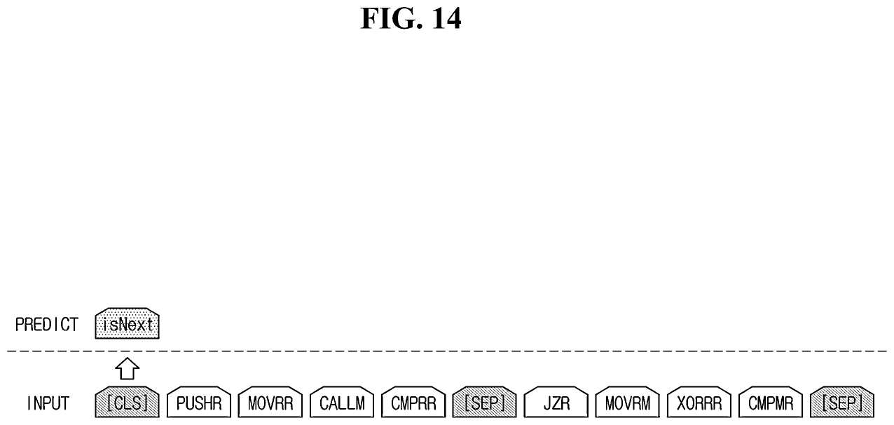

A second task for prelearning the assembly language model 231 is a next sentence prediction (NSP) task using an instruction code sequence. As illustrated in FIG. 14, a binarized NSP task is performed to understand a contextual relation of an instruction sequence. An NSP task may be simply generated in an instruction sequence dataset. As an example of prelearning, when two instruction sequences A and B are selected, an actual instruction sequence following A is selected 50% of the times of selecting B, and an instruction sequence randomly selected in a dataset is used the remaining 50% of those of selecting B. Herein, in case an actual instruction sequence following A is selected, it may be labeled IsNext.

An assembly language model, which is completely prelearned with an instruction code sequence of a whole dataset, may be stored for a downstream task to be performed later. Herein, the downstream task may be a malware binary classifier (or malicious code detection model).

As for the step (240) of learning a malware classifier based on an assembly language model, in the step (240) of learning a malware classifier based on an assembly language model, a malware binary classifier 241 is generated by adding a neural network layer for malicious code classification based on the prelearned assembly language model 231, and learning is performed using indexed instruction code sequence data labeled with malware and benign.

The malware binary classifier 241 may consist of an input layer receiving an input of an index instruction code sequence, an assembly language model that is prelearned with an instruction code, a 1D pooling layer, a fully connected layer with a ReLU activation function, and a binary classification layer with a sigmoid activation function. As an example, the input layer may have a size of 512 dimensions, the 1D pooling layer may have a size of 128 dimensions, and the fully connected layer may have a size of 64 dimensions. Adam may be used as an optimizer, and a binary cross entropy function may be used as a loss function.

For learning data for training the malware binary classifier 241, an instruction code sequence extracted from a malicious code is labeled malware, and an instruction code sequence extracted from a benign code is labeled benign, and then a training dataset indexed through an instruction code tokenizer and a test dataset are used.

After a malware binary classifier is configured, the malware binary classifier may be set not to train a learning parameter of a prelearned assembly language model, but to learn a parameter of a remaining layer by inputting training data, and after completely learning the training data, and to train a learning parameter the prelearned assembly language model, and then the malware binary classifier may be trained with test data.

A malware binary classifier model that is completely trained, that is, the malicious code detection model 241 may be separately stored for malware/benign classification of an unknown PE file, which is to be performed later.

The assembly language model 231 and the malicious code detection model 241 are learned through the above-described process, and the assembly language model and the malicious code detection model thus learned may be installed in a malicious code detection apparatus and may detect whether or not an unknown file is a malicious code.

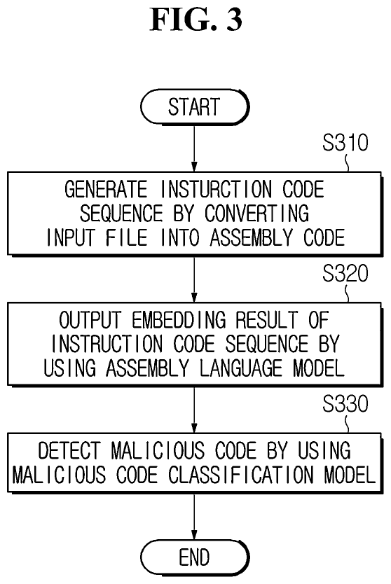

FIG. 3 is a flowchart for a method of detecting a malicious code according to another embodiment of the present disclosure.

Referring to FIG. 3, a method for detecting a malicious code according to another embodiment of the present disclosure includes generating an instruction code sequence by converting an input file for detecting a malicious code into an assembly code (S310), embedding an instruction code sequence by using a prelearned assembly language model for instruction code embedding and outputting an embedding result of the instruction code sequence (S320), and detecting a malicious code by using a prelearned malicious code classification model with an input of the embedding result (S330).

Step S310, which is a process of generating an instruction code sequence of an input file for detecting a malicious code of a format to be input into an assembly language model, may include a process of generating an indexed instruction code sequence corresponding to an instruction code sequence by using an instruction code dictionary for indexing an instruction code by an integer and by indexing an instruction code in an instruction code sequence by an integer.

Herein, at step S310, a plurality of segment instruction code sequences is generated by segmenting an instruction code sequence by a randomly selected length, and each of the plurality of segment instruction code sequences may be generated as an individual file.

Furthermore, at step S310, an instruction may be extracted from an assembly code, an instruction code may be generated by combining an opcode of the extracted instruction and an operand, and an instruction code sequence may be generated using the instruction code.

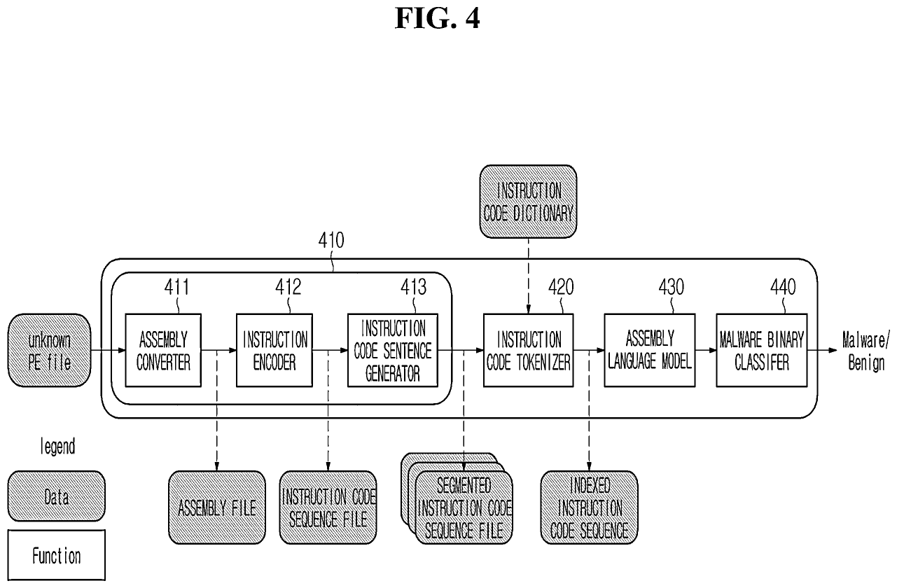

If the method of FIG. 3 is described with reference to FIG. 4, as illustrated in FIG. 4, after an input file is converted into an assembly code through an instruction collector 410 for an input file, an instruction code is generated by extracting an instruction from the assembly file, and an instruction code is generated as a sentence suitable for a learning data input format of an assembly language model.

Herein, the instruction collector 410 may be implemented by using an assembly converter 411 for converting an unknown PE file, which is an input file, into an assembly code, an instruction encoder 412 for extracting an instruction from an assembly code and for generating an instruction code by combining an opcode and an operand, and an instruction code sentence generator 413 for generating a sentence with an instruction code suitable for a learning data input format of an assembly language model.

As the assembly converter 411, the instruction encoder 412 and the instruction code sentence generator 413 are described in detail in FIG. 2, no further description is provided herein.

When the instruction collector 410 generates a segmented instruction code sequence file of an instruction for an unknown file, after the instruction code tokenizer 420 tokenizes (indexes) an instruction code sequence by using an instruction code dictionary that is used for prelearning of an assembly language model, an instruction code sequence is embedded by inputting an indexed instruction code sequence into the assembly language model 430 that is completely learned, and then an embedding result of the instruction code sequence is output. The malicious code classification model 440 checks whether an input unknown file is a malicious code or a benign code, by using the embedding result output from the assembly language model 430 as an input. Thus, in a method according to embodiments of the present disclosure, a technology of detecting an unknown malicious code based on an artificial intelligence may be used to generate an assembly language model through instruction information utilized for a static/dynamic malicious code analysis and to detect an unknown malicious code based on the model.

In addition, as a method according to embodiments of the present disclosure is capable of differentiating embedding according to a context within an instruction sequence even for a same instruction, it is capable of representing a further detail of the behavior of an instruction sequence, and thus since behavior patterns of sub-divided instruction sequences can be learned, the detection accuracy of a malware classifier may be enhanced.

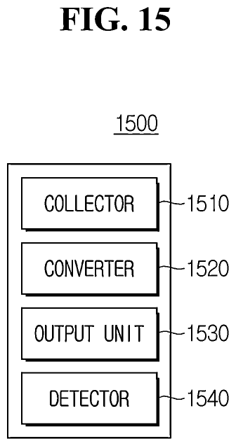

FIG. 15 is a view showing a configuration of a malicious code detection apparatus according to yet another embodiment of the present disclosure, and it is a view showing a conceptual configuration for an apparatus that implements a method of FIG. 1 to FIG. 14, and it is a view showing a state in which an assembly language model and a malicious code detection model are already learned and downloaded into an apparatus.

Referring to FIG. 15, a malicious code detection apparatus 1500 includes a collector 1510, a converter 1520, an output unit 1530 and a detector 1540.

The collector 1510 generates an instruction code sequence by converting an input file, which is to be checked regarding whether or not it has a malicious code, into an assembly code.

Herein, the collector 1510 may generate a plurality of segment instruction code sequences by segmenting the instruction code sequence by a randomly selected length and generate each of the plurality of segment instruction code sequences as an individual file.

Furthermore, the collector 1510 may extract an instruction from an assembly code, generate an instruction code by combining an opcode of the extracted instruction and an operand, and generate an instruction code sequence by using the instruction code.

The converter 1520 may generate an indexed instruction code sequence corresponding to an instruction code sequence by using an instruction code dictionary for indexing an instruction code by an integer and by indexing an instruction code in the instruction code sequence by an integer.

The output unit 1530 embeds an instruction code sequence by using an assembly language model, which is prelearned for embedding an instruction code, and outputs an embedding result of an instruction code sequence.

Herein, the output unit 1530 may output an embedding result of an indexed instruction code sequence by embedding an indexed instruction code sequence.

The detector 1540 detects a malicious code by using a prelearned malicious code classification model with an input of embedding result.

In addition, although not illustrated in FIG. 15, the malicious code detection apparatus 1500 may include a learning unit for prelearning an assembly language model and a malicious code detection model that are installed in the malicious code detection apparatus. Of course, the learning unit is a configuration means for learning an assembly language model and a malicious code detection model that are installed, and after the assembly language model and the malicious code detection model are learned, a configuration for the learning unit is not used to detect a malicious code.

Although not described in the apparatus of FIG. 15, an apparatus according to an embodiment of the present disclosure may include all the contents described in a method of FIG. 1 to FIG. 14, which are apparent to those who have skill in the art.

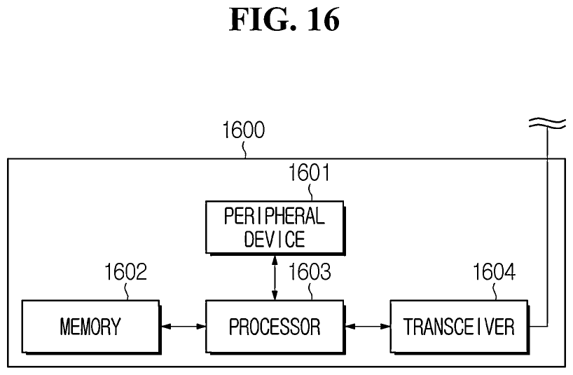

FIG. 16 is a view showing a configuration of a device to which a malicious code detection apparatus according to yet another embodiment of the present disclosure is applicable.

The malicious code detection apparatus according to an embodiment of the present disclosure of FIG. 15 may be a device 1600 of FIG. 16. Referring to FIG. 16, the device 1600 may include a memory 1602, a processor 1603, a transceiver 1604 and a peripheral device 1601. In addition, for example, the device 1600 may further include another configuration and is not limited to the above-described embodiment. Herein, for example, the device 1600 may be a mobile user terminal (e.g., a smartphone, a laptop, a wearable device, etc.) or a fixed management device (e.g., a server, a PC, etc.).

More specifically, the device 1600 of FIG. 16 may be an exemplary hardware/software architecture such as a malicious code detection device and a malicious code classification device. Herein, as an example, the memory 1602 may be a non-removable memory or a removable memory. In addition, as an example, the peripheral device 1601 may include a display, GPS or other peripherals and is not limited to the above-described embodiment.

In addition, as an example, like the transceiver 1604, the above-described device 1600 may include a communication circuit. Based on this, the device 1600 may perform communication with an external device.

In addition, as an example, the processor 1603 may be at least one of a general-purpose processor, a digital signal processor (DSP), a DSP core, a controller, a micro controller, application specific integrated circuits (ASICs), field programmable gate array (FPGA) circuits, any other type of integrated circuit (IC), and one or more microprocessors related to a state machine. In other words, it may be a hardware/software configuration playing a controlling role for controlling the above-described device 1600. In addition, the processor 1603 may be performed by modularizing the functions of the collector 1510, the converter 1520, the output unit 1530 and the detector 1540 of FIG. 15.

Herein, the processor 1603 may execute computer-executable commands stored in the memory 1602 in order to implement various necessary functions of the malicious code detection apparatus. As an example, the processor 1603 may control at least any one operation among signal coding, data processing, power controlling, input and output processing, and communication operation. In addition, the processor 1603 may control a physical layer, an MAC layer and an application layer. In addition, as an example, the processor 1603 may execute an authentication and security procedure in an access layer and/or an application layer but is not limited to the above-described embodiment.

In addition, as an example, the processor 1603 may perform communication with other devices via the transceiver 1604. As an example, the processor 1603 may execute computer-executable commands so that the malicious code detection apparatus may be controlled to perform communication with other devices via a network. That is, communication performed in the present invention may be controlled. As an example, the transceiver 1604 may send a RF signal through an antenna and may send a signal based on various communication networks.

In addition, as an example, MIMO technology and beam forming technology may be applied as antenna technology but are not limited to the above-described embodiment. In addition, a signal transmitted and received through the transceiver 1604 may be controlled by the processor 1603 by being modulated and demodulated, which is not limited to the above-described embodiment.

While the exemplary methods of the present disclosure described above are represented as a series of operations for clarity of description, it is not intended to limit the order in which the steps are performed, and the steps may be performed simultaneously or in different order as necessary. In order to implement the method according to the present disclosure, the described steps may further include other steps, may include remaining steps except for some of the steps, or may include other additional steps except for some of the steps.

The various embodiments of the present disclosure are not a list of all possible combinations and are intended to describe representative aspects of the present disclosure, and the matters described in the various embodiments may be applied independently or in combination of two or more.

In addition, various embodiments of the present disclosure may be implemented in hardware, firmware, software, or a combination thereof. In the case of implementing the present invention by hardware, the present disclosure can be implemented with application specific integrated circuits (ASICs), Digital signal processors (DSPs), digital signal processing devices (DSPDs), programmable logic devices (PLDs), field programmable gate arrays (FPGAs), general processors, controllers, microcontrollers, microprocessors, etc.

The scope of the disclosure includes software or machine-executable commands (e.g., an operating system, an application, firmware, a program, etc.) for enabling operations according to the methods of various embodiments to be executed on an apparatus or a computer, a non-transitory computer-readable medium having such software or commands stored thereon and executable on the apparatus or the computer.

What is claimed is:

1. A method for detecting a malicious code, the method comprising:
generating an instruction code sequence by converting an input file, for which a malicious code is to be detected, into an assembly code;
embedding the instruction code sequence by using a prelearned assembly language model for instruction code embedding and outputting an embedding result of the instruction code sequence; and
detecting whether or not the input file is a malicious code, by using a prelearned malicious code classification model with the embedding result as an input.

2. The method of claim 1, further comprising generating an indexed instruction code sequence corresponding to the instruction code sequence by using an instruction code dictionary for indexing an instruction code by an integer and by indexing an instruction code in the instruction code sequence by an integer,
wherein the outputting of the embedding result outputs an embedding result of the indexed instruction code sequence by embedding the indexed instruction code sequence.

3. The method of claim 1, wherein the generating of the instruction code sequence generates a plurality of segment instruction code sequences by segmenting the instruction code sequence by a randomly selected length.

4. The method of claim 3, wherein the generating of the instruction code sequence generates each of the plurality of segment instruction code sequences as an individual file.

5. The method of claim 1, wherein the generating of the instruction code sequence extracts an instruction from the assembly code, generates an instruction code by combining an opcode and an operand of the extracted instruction, and generates the instruction code sequence by using the instruction code.

6. A method for detecting a malicious code, the method comprising:
generating an instruction code sequence by converting each of a plurality of execution files into an assembly code;
learning an assembly language model for instruction code embedding by using the instruction code sequence; and
learning a malicious code classification model for detecting a malicious code based on the learned assembly language model.

7. The method of claim 6, further comprising generating an indexed instruction code sequence corresponding to the instruction code sequence by using an instruction code dictionary for indexing an instruction code by an integer and by indexing an instruction code in the instruction code sequence by an integer,
wherein the learning of the assembly language model learns the assembly language model by using the indexed instruction code sequence.

8. The method of claim 7, wherein the learning of the assembly language model learns the assembly language model by performing a masked language model (MLM) task and a next sentence prediction (NSP) task of the assembly language model by using the indexed instruction code sequence.

9. The method of claim 7, wherein the learning of the assembly language model learns the assembly language model by treating the indexed instruction code sequence as a sentence and by treating each instruction code as a token.

10. The method of claim 9, wherein the learning of the assembly language model learns the assembly language model by using a vector that adds token embedding for the indexed instruction code sequence, position embedding for a position of an instruction code, and segment embedding for distinguishing two indexed instruction code sequences.

11. The method of claim 6, wherein the generating of the instruction code sequence generates a plurality of segment instruction code sequences by segmenting the instruction code sequence by a randomly selected length.

12. The method of claim 11, wherein the generating of the instruction code sequence generates each of the plurality of segment instruction code sequences as an individual file.

13. The method of claim 6, wherein the generating of the instruction code sequence extracts an instruction from the assembly code, generates an instruction code by combining an opcode and an operand of the extracted instruction, and generates the instruction code sequence by using the instruction code.

14. An apparatus for detecting a malicious code, the apparatus comprising:
a collector configured to generate an instruction code sequence by converting an input file, for which a malicious code is to be detected, into an assembly code;
an output unit configured to embed the instruction code sequence by using a prelearned assembly language model for instruction code embedding and to output an embedding result of the instruction code sequence; and
a detector configured to detect whether or not the input file is a malicious code, by using a prelearned malicious code classification model with the embedding result as an input.

15. The apparatus of claim 14, further comprising a converter configured to generate an indexed instruction code sequence corresponding to the instruction code sequence by using an instruction code dictionary for indexing an instruction code by an integer and by indexing an instruction code in the instruction code sequence by an integer,
wherein the output unit is further configured to output an embedding result of the indexed instruction code sequence by embedding the indexed instruction code sequence.

16. The apparatus of claim 14, wherein the collector is further configured to generate a plurality of segment instruction code sequences by segmenting the instruction code sequence by a randomly selected length.

17. The apparatus of claim 16, wherein the collector is further configured to generate each of the plurality of segment instruction code sequences as an individual file.

18. The apparatus of claim 14, wherein the collector is further configured to:
extract an instruction from the assembly code,
generate an instruction code by combining an opcode and an operand of the extracted instruction, and
generate the instruction code sequence by using the instruction code.
